(19) United States
(12) Patent Application Publication
(10) Pub. No.: US 2003/0088443 A1
(43) Pub. Date: May 8, 2003

(54) System and method for personalizing and delivering insurance or financial services-related content to a user

(76) Inventors: Matthew George Majikes, Richmond, VA (US); Laura Louise Stenger, Chesterfield, VA (US)

Correspondence Address: Ozzie A. Farres, Esq., Hunton & Williams, Suite 1200, 1900 K Street, Washington, DC, 20006, US

(21) Appl. No.: 09/986,354

(22) Filed: Nov. 8, 2001

(51) Int. Cl. G06F 17/60

(52) U.S. Cl. 705/4; 705/27; 705/35

(57) ABSTRACT

A system and method for personalizing and delivering insurance or financial services-related content to a user. The system comprising a filtering module associated with an engine for determining information about the user, and for personalizing and delivering the insurance or financial services-related content based on the information about the user, the engine being accessible to the user over a communications network. Also provided is an administration module associated with the engine for inputting, updating, and accessing information about the user and insurance or financial services-related content available to the user, the administration module being accessible to an administrator of the system via an administration interface.

### BACKGROUND OF THE INVENTION

The present invention relates generally to a system and method for personalizing and delivering insurance or financial services-related content, and more particularly to a system and method for personalizing and delivering insurance or financial services-related content to a user based on information about the user.

The insurance and financial services industry is a highly complicated industry. The relationship between an insurance company and its agents (or producers) is particularly complex. As in any agency or firm relationship, the insurance company, acting as principal, develops and creates various insurance and financial products and services that are brokered or made available to the consuming public through its producers. The producers are located throughout the country (and world), and each producer offers its customers only those products and services which the insurance company authorizes it to market and sell.

Typically, the business relationship between an insurance company and a producer is controlled by a sales agreement that spells out particulars of the relationship, such as the products and services to be offered by the producer or agency, the geographic area in which the products and services are to be offered, and the term of the agency or firm relationship. Other particulars may also be included in the sales agreement.

During the course of their relationship, a producer and an insurance company frequently have the need to communicate regarding the products and services offered. For example, a producer may contact the insurance company to request literature or other information regarding the various products and services it is authorized to sell, or to inquire about other producers that are authorized to offer particular products or services. In fulfilling the producer's request, the sales agreement serves as a useful tool for the insurance company to identify those products and services that the producer is authorized to offer customers, as well as to identify all producers authorized to offer a particular product or service. Armed with this information, the insurance company may provide the producer or agency with the requested information.

One problem with this approach, however, concerns a lack of widespread access to sales agreements. For example, an insurance company representative taking requests from producers may not have immediate access to the sales agreements, and, thus, may not be able to efficiently and reliably fulfill a producer or agency's request for information. Further, sales agreements accessed by insurance company representatives may not be up to date resulting in the provision of erroneous information to a producer or agency or firm.

These and other drawbacks exist.

### BRIEF SUMMARY OF THE INVENTION

Accordingly, the present invention provides a system and method for personalizing and delivering insurance or financial services-related content to a user. The system comprises a filtering module associated with an engine for determining information about the user, and for personalizing and delivering the insurance or financial services-related content based on the information about the user, the engine being accessible to the user over a communications network; and an administration module associated with the engine for inputting, updating and accessing information about the user and the insurance or financial services-related content available to the user, the administration module be accessible to an administrator of the system via an administration interface.

The invention includes, in another aspect, a method for personalizing delivery of insurance or financial services-related content to a user. The method comprises the steps of determining information about the user using a filter module associated with an engine, the engine being accessible by the user over a communications network; personalizing the insurance or financial services-related content based on the information about the user; and delivering the insurance or financial services-related content to the user.

### BRIEF DESCRIPTION OF THE DRAWINGS

FIG. 1 is a schematic representation of a system for personalizing and delivering insurance or financial services-related content to a user according to an embodiment of the invention.

FIG. 2 is a schematic representation of the server station of FIG. 1 according to an embodiment of the invention.

FIG. 3 is a flow chart process for personalizing and delivering insurance or financial services-related content to a user according to one embodiment of the invention.

### DETAILED DESCRIPTION OF THE INVENTION

Reference will now be made to the present preferred embodiment of the invention, an example of which is illustrated in the accompanying drawings in which like reference characters refer to corresponding elements.

The present invention is described in relation to a system and method for personalizing and delivering insurance or financial services-related content to a user. Nonetheless, the characteristics and parameters pertaining to the system and method may be applicable to personalizing and delivering other types of content.

As described herein, the system and method of the invention may generally be used to facilitate interaction between an insurance company and its various producers, particularly as it relates to each producer's (or agency's) authorized representations and the products and services that may be offered or sold in accordance therewith. According to one embodiment, using the system and method of the invention a producer may interact with an insurance company over a communications network in a unique and personalized manner. In this embodiment, content delivered to the producer by the insurance company may be personalized and customized based on information about the producer, such as the identity of the producer.

In another embodiment, the system and method of the invention may be used by numerous producers to access or inquire about insurance or financial services-related content, such as information on products and services they are authorized to sell. Typical products or services may include, but are not limited to, mutual funds, annuities, life insurance, term life insurance, long term care insurance, supplemental health insurance, auto insurance, auto warranty programs, and employee benefit plans. Specifically, the producers may desire to obtain promotional information about these products and services from the insurance company to provide to its customers. The desired information may include, but is not limited to, any type of literature, brochures, or pamphlets that explain or describe the relevant products and services. According to one embodiment, the personalized information may be viewed by the producer on a screen, monitor, or other display device associated with the producer's computer or access terminal. In this embodiment, the information (or documents) may be viewed in PDF, or other like document format. In another embodiment, the system may transfer the producer to a particular URL address where the personalized information may be viewed. In yet another embodiment, the producer may wish to arrange for delivery of hard copies of the information (or documents) requested.

For example, assume a Virginia producer of an insurance company logs-on to the system desiring to obtain literature regarding the products it its authorized to sell in the state. In one embodiment, the system may identify the producer automatically based on the producer's IP address, or other like identifier associated with the terminal or computer being used by the producer. In another embodiment, the producer may be identified based on log-in information provided by the producer, such as a username and a password. Once the producer is identified, the system proceeds to access insurance or financial services-related information content particular to the producer. The producer may then arrange to view the information content, to download the information content to his or her computer, or to request that the information content be delivered to a designated address via U.S. mail, express mail, or any other like delivery service. In the last example, the system may, upon taking the order or request from the producer, coordinate delivery with a corresponding fulfillment vendor, or may itself carry out delivery of the information.

In another example, the Virginia producer may desire information about variable annuities offered by the insurance company through an agency or firm with which the producer is associated. According to this example, the system may identify the producer and thereafter determine the agency or firm with which the producer is associated. Based on this information, the system may present the producer with information content regarding those products the agency or firm is authorized to offer. Further, the information content delivered to the producer may additionally be filtered or limited based on the producer's profile, such as variable annuities offered through the agency or firm within the state of Virginia. That is, the system may filter information content to be delivered based on information about the agency or firm and the producer.

Another aspect of the system and method of the invention concerns the insurance company's ability to input and maintain producer and agency or firm profiles that can be used to personalize interaction between the producers and the system of the invention. In one embodiment, the producer and agency or firm information may be stored within a database associated with the system and may be modified, corrected, or updated as required by the insurance company. Further, in another embodiment, the insurance company may input and maintain product and service profiles that, in conjunction with the producer and agency or firm profiles, may be used to personalize and customize interaction between the insurance company and its producers. In one embodiment, the product and service information may be stored within a database associated within the system, and may be modified, corrected, or updated as required by the insurance company. In another embodiment, the insurance company may input product and service information using a scanning device associated with the system. In yet another embodiment, the product and service information may be located at a separate URL address, to which a user or producer can be transferred to.

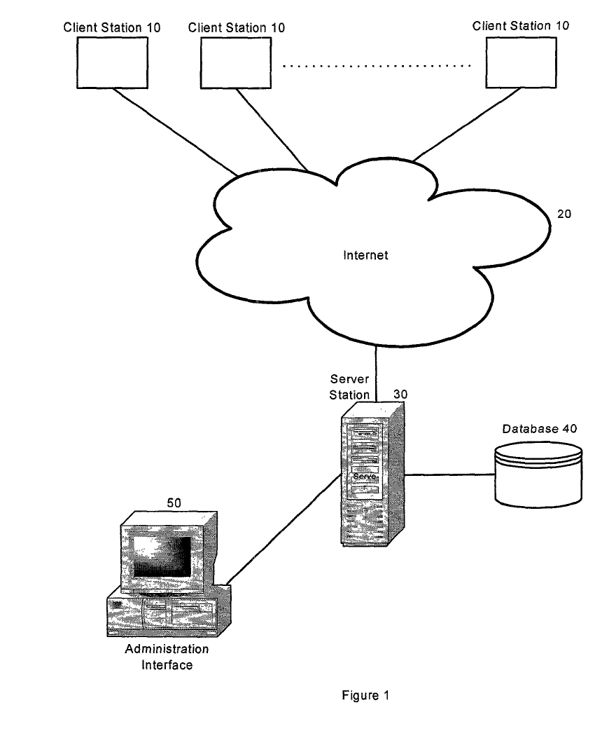

FIG. 1 illustrates one embodiment of a system 100 of the invention. As shown, the system 100 may include a plurality of client stations 10 that may be accessed by individual producers (or agencies) to access, request, or inquire about insurance or financial services-related content. In one embodiment, each client station 10 may be located wherever a producer or agency resides. In another embodiment, a client station 10 may be portable to provide maximum accessibility to the producer or agency or firm. Client stations 10 may be or include, for instance, a personal or laptop computer running a Microsoft Windows™ 95 operating system, a Windows™ 98 operating system, a Millenium™ operating system, a Windows NT™ operating system, a Windows™ 2000 operating system, a Windows XP™ operating system, a Windows CE™ operating system, a PalmOS™ operating system, a Unix™ operating system, a Linux™ operating system, a Solaris™ operating system, an OS/2™ operating system, a BeOS™ operating system, a MacOS™ operating system, a VAX VMS operating system, or other operating system or platform. Client stations 10 may include a microprocessor such as an Intel x86-based or Advanced Micro Devices x86-compatible device, a Motorola 68K or PowerPC™ device, a MIPS device, Hewlett-Packard Precision™ device, or a Digital Equipment Corp. Alpha™ RISC processor, a microcontroller or other general or special purpose device operating under programmed control. Client stations 10 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Client stations 10 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Client stations 10 may also include a network-enabled appliance such as a WebTV™ unit, a radio-enabled Palm™ Pilot or similar unit, a set-top box, a networkable game-playing console such as a Sony™ Playstation™, Sega™ Dreamcast™ or a Microsoft™ XBox™, a browser-equipped or other network-enabled cellular telephone, or another TCP/IP client or other device.

As shown in FIG. 1, client stations 10 are connected to a communications link 20. The communications link 20 may be, include or interface to any one or more of, for instance, the Internet, an intranet, a Personal Area Network (PAN), a Local Area Network (LAN), a Wide Area Network (WAN) or a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, V.34 or V.34bis analog modem connection, a cable modem, an Asynchronous Transfer Mode (ATM) connection, or a Fiber Distributed Data Interface (FDDI) or Copper Distributed Data Interface (CDDI) connection. The communications link 20 may further include or interface to any one or more of a Wireless Application Protocol (WAP) link, a General Packet Radio Service (GPRS) link, a Global System for Mobile Communication (GSM) link, a Code Division Multiple Access (CDMA) or Time Division Multiple Access (TDMA) link such as a cellular phone channel, a Global Positioning System (GPS) link, cellular digital packet data (CDPD), a Research in Motion, Limited (RIM) duplex paging type device, a Bluetooth, BlueTeeth or WhiteTooth radio link, or an IEEE 802.11 (Wi-Fi)-based radio frequency link. The communications link 20 may further include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

Also connected to the communications link 20, and thereby accessible to producers or agencies using client stations 10, is a server station 30. The server station 30 may host one or more applications that function to personalize and customize interaction between the insurance company and producers. For example, the server station 30 may include a module that identifies the producer accessing the system 100 and thereafter personalizes the session based on information about the producer. In one embodiment, the session is personalized based on the producer's identity. In another embodiment, the session may be personalized based on the agency or firm with which the producer is associated. Other functional modules may be provided. The server station 30 may include, for instance, a workstation running the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

A producer can access the server station 30 via the communications link 20 using a client station 10. As was mentioned above, interaction between the system 100 of the invention and a producer is personalized based on information about the producer. The information upon which a session may be personalized may, in one embodiment, comprise determining the identity of the producer or agency accessing the system 100. Identification may be determined automatically by the system 100 based on the producer's IP address or other similar identifier, or may be based on login data or information provided by the producer, such as the producer's predetermined user name and a password. In another embodiment, the session may be personalized based on the agency or firm with which the producer is associated. Other information may be used to personalize the session.

Information relied on by the system 100 to personalize the session may be stored in a database 40, as shown in FIG. 1. The database 40 may include or interface to, for example, an Oracle™ relational database sold commercially by Oracle Corporation. Other databases, such as an Informix™ database, Database 2 (DB2) database, a Sybase™ database or another data storage or query format, platform or resource such as an On Line Analytical Processing (OLAP) data storage facility, a Standard Query Language (SQL) data storage facility, a storage area network (SAN) facility, or a Microsoft Access™ database or other similar database platform or resource. The database 40 may be supported by a server or other resources, and may include redundancy, such as a redundant array of independent disks (RAID), for data protection. For example, the database 40 and the server station 30 may comprise an OLAP system that generates a plurality of user-specific reports from data maintained by the database 40. In another example, the server station 30 may be associated with or connected to a database server (not shown) that serves to present queries against the database 40. The database server may comprise an OLAP server system for accessing and managing data stored in the database 40. The database server may also comprise a Relational On Line Analytical Processing (ROLAP) engine, a Multi-dimensional On Line Analytical Processing (MOLAP) engine, or a Hybrid On Line Analytical Processing (HOLAP) engine according to different embodiments. Specifically, the database server may comprise a multithreaded server for performing analyses directly against the database 40.

Information stored in the database 40 may be input and administered by a representative of the insurance company via an administration interface 50. Information entered by the representative may, in one embodiment, correspond to information contained in a sales agreement entered into between the insurance company and an individual producer or an agency or firm. For instance, the representative may input information about each producer or agency, such as identification information, location information, agencies or firms with which a producer is affiliated, an area or a territory covered by a producer or agency or firm, a plurality of products and services each producer or agency or firm is authorized to offer or sell its customers, and any other relevant information. The inputted information may be stored and updated, as necessary.

For instance, assume a Virginia producer is authorized to sell only insurance products within the state. The representative of the insurance company can use the administration interface to input the Virginia producer's name, location, and all of the products and services the producer is authorized to offer. Any future inquiries by the producer for information related to the products and services offered will accordingly be limited to information relating to the insurance products. The information may be stored in the database 40, and may be updated should the producer be authorized to offer additional products and services in the future.

The administration interface 50 may further include or be associated with a scanning device 55 for scanning and uploading a plurality of documents, images, and other information that may relate to information about insurance products and services. Specifically, the scanning device 55 may be used by a representative of the insurance company to upload literature and pamphlets, brochures, and other documentation relating to the products and services offered by the insurance company. Uploaded information may, in one embodiment, be stored in the database 40 for future access and retrieval.

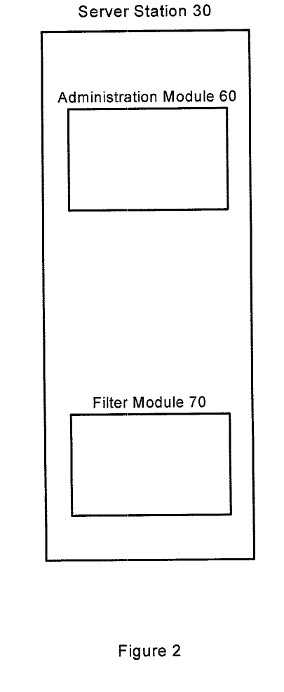

The server station 30 is shown in more detail in FIG. 2. As shown, the server station 30 may include an administration module 60 that may be accessed by the insurance company via the administration interface 50 to monitor or control operation of the system 100, create, input or update information stored in the database 40, such as information regarding producers or products and services offered by the insurance company. Other information may be administered or inputted. For example, the administration module 60 may query a representative of the insurance company to input information regarding a producer or agency, such as identification information, a plurality of products and services the producer is authorized to offer, a geographic area(s) where the producer is authorized to operate, and any other information relevant to the producer's duties and responsibilities to the insurance company. Additionally, the administration module 60 may also query the representative of the insurance company to input a name of each of the plurality of products and services each producer or agency or firm is authorized to offer. The administration module 60 may also be used by a representative of the insurance company to monitor of the system 100's overall operation. For instance, the insurance company may monitor producer or agency or firm participation, as well as the popularity of its numerous products and services.

The server station 30 may also include a filter module 70 for determining information about a producer or agency or firm, and for personalizing and delivering insurance or financial services-related content to a user. By way of example, after an authorized user properly logs-on to the server station 30, the filter module 70 may determine information about the user in order to personalize or customize interaction between the system and the user. According to one embodiment, the filter module 70 automatically identifies the user based on the user's IP address, and thereafter accesses information stored in the database 40 based on the user's identification. In another embodiment, the filter module 70 determines the user's identity based on login information provided by the user, such as the user's username and password, and accesses information stored in the database 40 relating to the identified user. In yet another embodiment, information other than user identity may be used to personalize the session. For example, the filter module 70 may determine the user's historical access pattern and therefrom deliver personalized content consistent with such pattern. According to this example, the system 100 may determine that each time the particular user accesses the system, he or she inquires about automobile insurance policies. Based on this pattern, the filter module 70 can determine that the user is interested in obtaining information about automobile insurance policies and automatically delivers such information to the user.

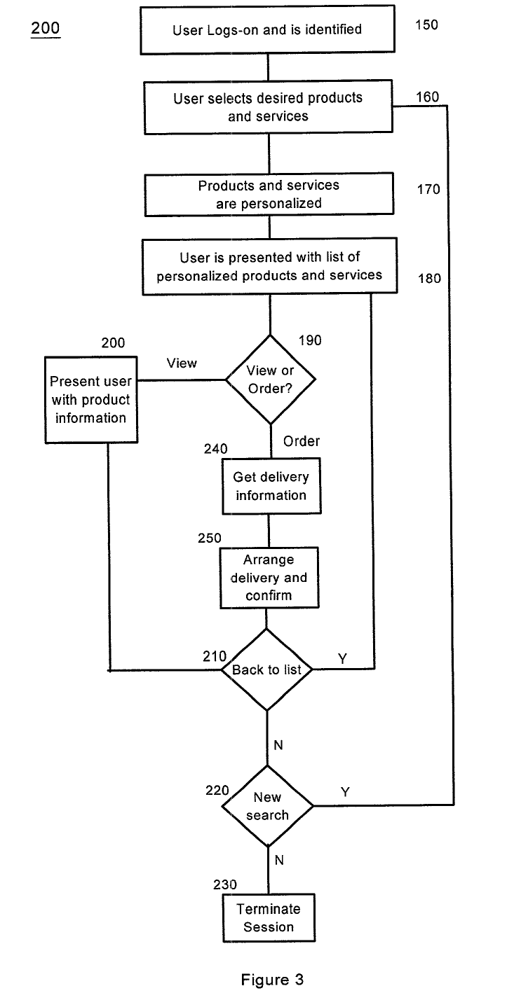

FIG. 3 relates to a method 200 for personalizing and delivering insurance or financial services-related content to a user, according to an embodiment of the invention. Specifically, the method 200 relates to a plurality of procedures followed by a producer and the system 100 in coordinating a personalized and unique information session. For example, a producer of an insurance company may use the client station 10 to access a web site on the Internet that, according to one embodiment of the invention, offers information to producers regarding a plurality of insurance and financial products and services offered by the company. The information may comprise literature such as pamphlets, brochures, forms, etc., that may relate to the various products and services offered by the insurance company. According to one embodiment, the web site may provide the functionality described above in connection with the system 100 of FIGS. 1 and 2.

Upon accessing the website, the producer may log-in to the system 100, at step 150. In one embodiment, this may be accomplished by requiring the producer to enter personal information such as a username or a password, or may be done automatically by the filter module 70 by recognizing the IP address of the computer or terminal from which the producer is operating. In the first example, the username and the password may be unique to the individual producer, or may correspond to an agency or firm with which the producer is associated. Likewise, in the latter example, the IP address may be associated with the individual producer, or may correspond to an agency or firm with which the producer is associated.

Once the producer logs-in to the system 100, at step 160, he or she may be presented with several options for obtaining information and literature on products and services offered by the company. In one embodiment, the producer is presented with a screen showing various categories corresponding to different types of products and services, such as automobile policies, home policies, life policies, mutual funds, employee benefit plans, etc. Each category may correspond to numerous products and services offered by the insurance company under that heading. The producer may browse the various categories and select the one corresponding to the product(s) or service(s) he or she desires information about. In another embodiment, the producer may be presented with a standard search box that allows the producer to enter a key word(s) corresponding to the desired products and services. Other options for obtaining information are possible.

Once the producer selects the product or service on which he or she would like further information—either by choosing a category or entering a search term—at step 170, the filter module 70 may, in one embodiment, query the database 40 for all of the products and services relating to the producer's request. In the instance where the producer selects a category, for example, the filter module 70 may query the database 40 for all products and services that fall within the selected category. For example, assume our hypothetical Virginia producer selects a product category titled, “Variable Annuities.” The query against the database 40 may return a list of all variable annuities offered by the insurance company. Should, however, the producer conduct a key word search, the filter module 70 would query the database 40 for those products and services whose names contain the search term entered by the producer. For example, assume the Virginia producer enters the term “Employee.” The query against the database 40 may return a list of products and services offered by the insurance company relating to employee benefit plans, for example.

In either case, before presenting the resulting lists of products and services to the producer, the filter module 70 may further narrow the list to only those products and services that are authorized by the insurance company. In one embodiment, the list may be limited to those products and services the producer is authorized to sell or offer, while another embodiment limits the list to those products and services the agency or firm associated with the producer is authorized to sell or offer. Other limitations are possible. This way, a producer accessing the web site is able to obtain personalized and customized information in an automatic and dynamic way. That is, by using the system 100 and method 200 of the invention a producer selecting the category of “variable annuities” may receive a list of variable annuities that he and/or his agency or firm is authorized to sell or offer. Similarly, a producer entering a key word search for “employee” may receive a list of employee benefit plans he or his agency or firm is authorized to sell or offer.

Once personalization is accomplished by the filter module 70, at step 180, the producer may be presented with the personalized list of products and services resulting from the query against the database 40. According to one embodiment, the names of the products and services are presented to the producer for viewing on the monitor, screen, or other display device associated with the client station 10. According to one embodiment, the presented list may designate those products and services, if any, for which information or literature may be viewed on the screen or ordered for mail delivery. For instance, a particular brochure relating to automobile insurance may be available for viewing on the producer's screen, or may be ordered for delivery to the producer's address.

At step 190, therefore, the producer selects the specific products and services for which it would like to view or order information or literature. If the producer chooses to view information or literature on a particular product or service, such information may be graphically presented on the user's screen. In one embodiment, the product or service information is presented in a PDF file format, or other like format. In another embodiment, the producer may be transferred to a URL address that contains the product or service information for viewing. In either case, the producer will be presented with the requested product or service information on the screen, and may have the option of simply viewing the information, downloading the information, or printing the information on a printer device (not shown) associated with the client station 10. As was stated above, the information (i.e., document, brochure, pamphlet, or other literature) may have previously been uploaded into the database 40, for example, by a representative of the insurance company using the scanning device 55 associated with the administration interface 50.

Once the producer views the selected information, he may, at step 210, opt to return to the main list of personalized products and services. Should the producer wish to do so, he will be transferred back to the list of products and services (step 180) and be given the opportunity to view or order additional information on other products and services. If the producer does not wish to return to the list, he or she will be presented with the opportunity, at step 220, to conduct a new search for products and services. If the producer opts to conduct a new search, he or she will be transferred back to step 160 where they may select a new category of products and services, or conduct a key word search. If, however, the producer does not wish to conduct a new search, then the session between the producer and the system may be terminated, as indicated at step 230.

Returning to step 190, if the producer desires to order the information for delivery rather than simply view it, the system may, at step 240, query or prompt the producer for any and all information relevant to delivery of the selected product or service. For example, the system 100 may query the producer to input the quantity of information desired (i.e., the total number of pamphlets or brochures desired), the address to which the information is to be sent, the date by which delivery is desired, etc. Other information may be requested. According to one embodiment, the system may store the producer's address and other information so that subsequent requests for delivery by the producer will not require the producer to re-enter the previously provided information.

Once the producer provides the necessary information, the filter module 70 arranges for delivery of the requested information. According to one embodiment, the filter module 70 may initiate processing of the order by electronically forwarding the order and delivery information to a fulfillment vendor responsible for processing such requests. Upon acceptance of the order by the fulfillment vendor or appropriate department, the filter module 70 sends a confirmation to the producer that the order has been processed. In one embodiment, the confirmation may be sent directly to the producer during the session. In another embodiment, confirmation may be sent via electronic mail or other traditional mail delivery service.

Once the delivery of the order is processed and confirmation received by the producer, the producer may, at step 210, opt to return to the list of personalized products and services. Should the producer wish to do so, he will be transferred back to the list of products and services (step 180) and be given the opportunity to view or order for delivery additional information on other products and services. If the producer does not wish to return to the list, he or she will be presented with the opportunity, at step 220, to conduct a new search for insurance or financial services-related content. If the producer opts to conduct a new search, he or she will be transferred back to step 160 where they may select a new category of products and services, or conduct a key word search. If, however, the producer does not wish to conduct a new search, then the session between the producer and the system may be terminated, as indicated at step 230.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A system for personalizing and delivering insurance or financial services-related content to a user, comprising:
a filtering module associated with an engine for determining information about the user, and for personalizing and delivering the insurance or financial services-related content based on the information about the user, the engine being accessible to the user over a communications network; and
an administration module associated with the engine for inputting, updating and accessing information about the user and the insurance or financial services-related content available to the user, the administration module being accessible to an administrator of the system via an administration interface.

2. The system of claim 1 wherein the insurance or financial services-related content is delivered to the user over the communications network.

3. The system of claim 2 wherein the insurance or financial services-related content is delivered in PDF format.

4. The system of claim 2 wherein the insurance or financial services-related content delivered to the user is located at a URL address.

5. The system of claim 1 wherein the insurance or financial services-related content is delivered to the user via mail delivery means.

6. The system of claim 5 wherein the mail delivery means comprises the United States Postal Service.

7. The system of claim 5 wherein the mail delivery means comprises express delivery service.

8. The system of claim 1 wherein the administration interface further comprises scanning means for uploading insurance or financial services-related information.

9. The system of claim 1 wherein the information about the user and the insurance or financial services-related content are stored in a database.

10. The system of claim 1 wherein the information about the user comprises the user's identity.

11. The system of claim 1 wherein the information about the user comprises log-in information such as user name and password.

12. The system of claim 1 wherein the insurance or financial services-related content comprises information about insurance products and services available to the user.

13. The system of claim 1 wherein the insurance or financial services-related content comprises literature about insurance products and services available to the user.

14. The system of claim 1 wherein the communications network comprises the Internet.

15. A method for personalizing delivery of insurance or financial services-related content to a user, comprising the steps of:
determining information about the user using a filter module associated with an engine, the engine being accessible by the user over a communications network;
personalizing the insurance or financial services-related content based on the information about the user; and
delivering the insurance or financial services-related content to the user.

16. The method of claim 15 wherein the insurance or financial services-related content is delivered to the user over the communications network.

17. The method of claim 15 wherein the insurance or financial services-related content is delivered to the user via mail delivery means.

18. The method of claim 15 wherein delivering the insurance or financial services-related content comprises transferring the user to a URL address containing the insurance or financial services-related content.

19. The method of claim 15 wherein the information about the user comprises the user's identity.

20. The method of claim 19 wherein the user's identity is automatically determined upon the user accessing the filter module.

21. The method of claim 19 where the user's identity is determined based on the user's username and password.

22. The method of claim 15 wherein the insurance or financial services-related content comprises information about insurance products and services available to the user.

23. The method of claim 20 wherein the insurance or financial services-related content comprises literature relating to products and services available to the user.

24. The method of claim 20 wherein the information about the user is stored in a database.

25. A method for a user to obtain personalized insurance or financial services-related content, comprising:
accessing a filter module associated with an engine for determining information about the user, and for personalizing the insurance or financial services-related content based on information about the user, the engine being accessible to the user of a communications network; and
receiving the insurance or financial services-related content.

26. The method of claim 25 wherein the insurance or financial services-related content is received over the communications network.

27. The method of claim 25 wherein the insurance or financial services-related content is received via mail delivery means.
